(19) United States
(12) Patent Application Publication
(10) Pub. No.: US 2011/0204244 A1
(43) Pub. Date: Aug. 25, 2011

(54) Neutron Detector

(76) Inventors: Thomas M. Haard, Clarksville, MD (US); Joan A. Hoffmann, Clarksville, MD (US)

(21) Appl. No.: 12/859,302

(22) Filed: Aug. 19, 2010

Related U.S. Application Data
(60) Provisional application No. 61/235,210, filed on Aug. 19, 2009.

(51) Int. Cl. G01T 3/06

(52) U.S. Cl. 250/369

(57) ABSTRACT

A neutron detector is disclosed. The neutron detector includes an optically transparent, low density solid porous matrix containing nanoparticles of a neutron absorbing material having a neutron absorption capture cross-section of at least about 70 barns, optionally doped with a scintillating material, for absorbing neutrons and emitting scintillation photons; and at least one detector element connected to the optically transparent neutron detector to detect fluorescence.

### CROSS-REFERENCE TO RELATED APPLICATIONS

This application claims the benefit of prior filed co-pending U.S. Provisional Application No. 61/235,210, filed Aug. 19, 2009, the contents of which are incorporated by reference herein.

### BACKGROUND OF THE INVENTION

1. Field of the Invention

The present invention generally relates to a neutron detector.

2. Description of the Related Art

The detection of neutrons is well known. For example, thermal neutron detection is usually accomplished with helium-3 tubes that are routinely incorporated into commercial instruments. Helium-3 tubes typically are filled with gas at pressures in excess of two atmospheres. Transportation of these tubes by air requires a waiver issued by the Department of Transportation; without this waiver, the tubes must be delivered by ground transportation. A tube's structure comprises a cylinder filled with gas in which a thin wire is strung axially under tension. This wire structure is susceptible to vibration and this causes false counts. Detectors based on helium-3 tubes, with suitable moderator around them, can be made to approach 100% intrinsic efficiency. However, helium-3 is becoming scarcer and more expensive due to an increased demand coupled with a dwindling supply.

One proposal as an alternative to helium-3 is the use of BF₃. However, BF₃ is believed to have an inferior response compared to helium-3 and is likewise a hazardous resource.

Glass scintillators for thermal neutron detection are commercially available. Saint-Gobain markets Li-loaded silicate glass made from a recipe approximately 40 years old. In addition, PNNL (Pacific Northwest National Laboratory) has produced Li-loaded glass fibers for neutron detection, and has licensed the process to Nucsafe, LLC. Nucsafe manufactures the fiber and uses it in both portable and fixed neutron detectors. A basic difficulty associated with Li-loaded glass scintillators is that the neutron response is not well distinguishable from the gamma response when there is a high gamma flux.

Accordingly, it would be desirable to provide an improved thermal neutron detector which can be made in a simple, cost efficient manner.

### SUMMARY OF THE INVENTION

In accordance with one embodiment of the present invention, there is provided a neutron detector comprising an optically transparent, low density solid porous matrix comprising nanoparticles of a neutron absorbing material having a neutron absorption capture cross-section of at least about 70 barns for absorbing neutrons and emitting scintillation photons; and at least one detector element connected to the optically transparent, low density solid porous matrix to detect fluorescence.

In accordance with a second embodiment of the present invention, there is provided a neutron detector comprising an optically transparent, low density solid porous matrix comprising nanoparticles of a neutron absorbing material having a neutron absorption capture cross-section of at least about 70 barns doped with a scintillating material for absorbing neutrons and emitting scintillation photons; and at least one detector element connected to the optically transparent, low density solid porous matrix to detect fluorescence.

In accordance with a third embodiment of the present invention, there is provided a neutron detector comprising an optically transparent, low density solid porous matrix comprising a neutron absorbing material comprising nanoparticles of an oxide of gadolinium for absorbing neutrons and emitting scintillation photons; and at least one detector element connected to the optically transparent, low density solid porous matrix to detect fluorescence.

In accordance with a fourth embodiment of the present invention, there is provided a neutron detector comprising an optically transparent, low density solid porous matrix comprising a neutron absorbing material comprising nanoparticles of an oxide of gadolinium doped with a rare earth element for absorbing neutrons and emitting scintillation photons; and at least one detector element connected to the optically transparent, low density solid porous matrix to detect fluorescence.

In accordance with a fifth embodiment of the present invention, there is provided a neutron detector comprising an optically transparent, low density solid porous matrix comprising nanoparticles of a neutron absorbing material doped with a scintillating material for absorbing neutrons and emitting scintillation photons; and at least one detector element connected to the optically transparent, low density solid porous matrix to detect fluorescence, wherein the optically transparent, low density solid porous matrix does not fluoresce under irradiation by gamma rays.

The neutron detectors of the present invention are portable, solid-based neutron detectors with high neutron sensitivity, low gamma sensitivity, and small volume. In addition, the neutron detectors of the present invention are based on an optically transparent, low density solid porous matrix such as an aerogel which advantageously capture neutrons by, for example, gadolinium nuclei resulting in an Auger electron emission within the aerogel. This, in turn, allows the electron to excite luminescent modes from the aerogel, thereby emitting, for example, optical scintillation photons. This optical light will propagate through the aerogel and will be detectable with at least one detector element such as a photomultiplier tube. The aerogel will have a relatively low gamma-ray interaction rate due to its small mass density and formation of nanoparticles of a neutron absorbing material having a neutron absorption capture cross-section of at least about 70 barns, thus providing a favorable large neutron/gamma discrimination ratio. In addition, the neutron detectors of the present invention can be hand held, self-contained, detectors.

### BRIEF DESCRIPTION OF THE DRAWINGS

Various embodiments are described below with reference to the drawings wherein:

FIG. 1 shows a neutron detector according to one embodiment of the present invention.

FIG. 2 shows a neutron detector according to one embodiment of the present invention.

### DETAILED DESCRIPTION OF PREFERRED EMBODIMENT(S)

The present invention is directed to a neutron detector based on an optically transparent, low density solid porous matrix comprising a neutron absorbing material optionally doped with a scintillating material. The term “optically transparent’ as used herein shall be understood to mean a low density solid porous matrix which is partially to fully transparent, i.e., a solid porous matrix which is at least about 50% transparent. The optically transparent, low density solid porous matrix absorbs neutrons by way of the nanoparticles of the neutron absorbing material which, in turn, convert the neutrons to scintillation photons. The emitted photons can be detected using methods well known in the art, such as a photomultiplier, a photodiode, a charge coupled device, a microchannel plate, a channeltron or an avalanche photodiode.

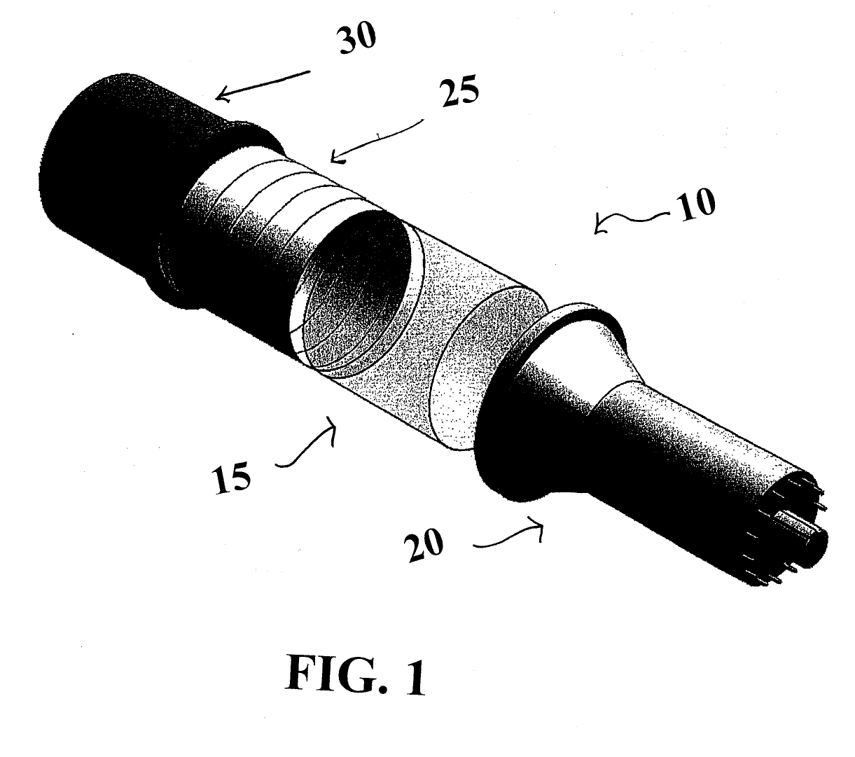

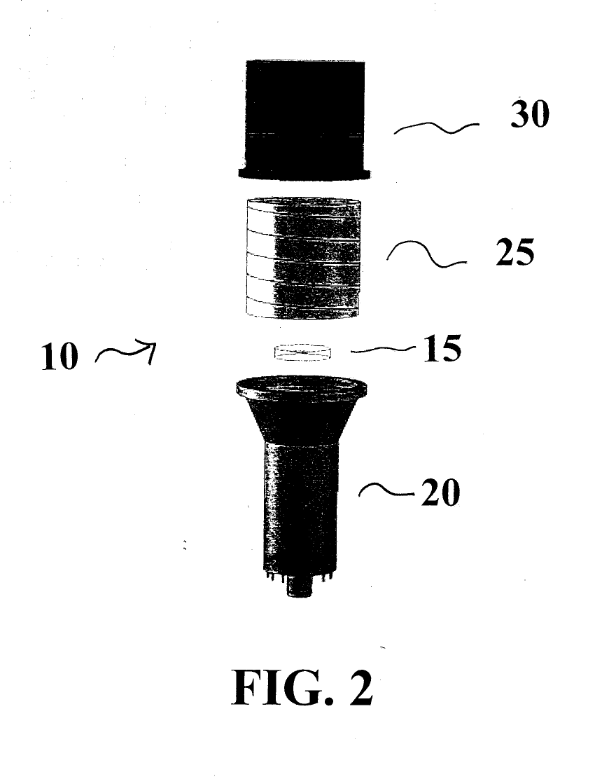

Referring now to FIGS. 1 and 2, an example includes neutron detector 10 comprising an optically transparent, low density solid porous matrix 15; and at least one detector element 20 connected to the optically transparent neutron detector to detect fluorescence. Optically transparent, low density solid porous matrix 15 is formed from nanoparticles of a neutron absorbing material having a neutron absorption capture cross-section of at least about 70 barns and, optionally, a scintillating material.

Suitable for use as neutron absorbing material are those element(s) with high neutron capture cross section which are able to generate high-energy particles as a result of the nuclear reaction, i.e., a neutron absorption capture cross-section of at least about 70 barns. In one embodiment, a high neutron capture cross section includes a neutron absorption capture cross-section of from about 70 barns to about 100,000 barns or even higher. In one embodiment, a high neutron capture cross section includes a neutron absorption capture cross-section of from about 100 barns to about 100,000 barns or even higher. In one preferred embodiment, it is advantageous that the neutron absorbing material when dispersed at sufficiently low density be substantially transparent to incoming gamma radiation yet strongly absorbing of neutrons. Representative examples of such material include a compound of at least one element of Li, B, Gd, Dy and Eu. In one embodiment, the neutron absorbing material is Gd. In another embodiment, the neutron absorbing material is an oxide of Gd. In another embodiment, the neutron absorbing material is gadolinium sesquioxide.

Although the mean particle size of the nanoparticles of the neutron absorbing material is not always particularly limited, in one embodiment, each has a mean particle size which is suitable for effective neutron capture and effective scintillation behavior. For example, each can have a mean particle size of from about 1 nm to about 100 nm. In another embodiment, each can have a mean particle size of from about 2 nm to about 10 microns.

In one embodiment, the nanoparticles of the neutron absorbing material are doped with a scintillating material. The scintillating material can be one or more active ions. In one embodiment, the scintillating material can be any rare earth element. Representative examples of such earth elements include Tb, Dy, Ho, Eu, Tm, Yb and Lu. Any of the rare earth elements can be used alone or in combinations. In one embodiment, the neutron absorbing material is doped with Tb and/or Eu. Each nanoparticle in the low density solid porous matrix may be doped with the same or different active species.

The optically transparent, low density solid porous matrix of the present disclosure can be any type of shaped article. As used herein, “shaped articles” includes, but is not limited to: layers, sheets, rods, wires, nets, lenticular fixtures, fibers, etc.; complex bodies, etc. All of these aforementioned “shaped articles” constitute “articles” according to the present disclosure and claims. In general, the low density solid porous matrix can have a thickness of about 1 millimeter (mm) to about 1 meter (m).

In one embodiment, the optically transparent, low density solid porous matrix does not contain silica. In another embodiment, the optically transparent, low density solid porous matrix does not contain glass.

In one embodiment, the neutron detector is obtained from a sol-gel method for preparing aerogels composed of neutron absorbing nanoparticles such as gadolinium sesquioxide (Gd₂O₃) nanoparticles. The nanoparticles are of a crystalline form having a primary particle size between about 2 nanometer (nm) and about 100 nm.

The solid porous matrix is an optically transparent, low density solid porous matrix, e.g., a solid having a density of about 0.002 to about 0.2 g/cm³. In one embodiment, the solid porous matrix is an aerogel. In addition, in the case of an aerogel, the majority of the volume of the matrix or aerogel is air (or gas). Thus, a high fraction of the material present in the matrix is a neutron absorbing material.

The low density solid porous matrix such as an aerogel can be formed by methods known in the art, see, e.g., Zhang, H., B. Li, Q. Zheng, M. Jiang, X. Tao. “Synthesis and characterization of monolithic Gd2O3 aerogels.” Journal of Non-Crystalline Solids. 354: 4089-4093 (2008), the contents of which are incorporated by reference herein. In general, an “aerogel” is a low density sold product that remains when the liquid part of a gel like material is removed without damaging the solid part.

In one embodiment, the formation of a low density solid porous matrix such as an aerogel involves two steps, namely, the formation of a gel like material via a sol-gel process, and the drying of the gel like material to form an aerogel. The sol-gel process is a well-known and versatile solution process for making an aerogel, as well as other materials. In general, the sol-gel process involves the transition of a system from a mostly colloidal liquid sol into a solid gel phase. The sol gel processing is a low-temperature process requiring little or no heating. In one embodiment, the precursor or starting materials used in the preparation of the sol are usually a solution of the neutron absorbing material or a salt such as a chloride salt of the neutron absorbing material in a suitable solvent, e.g., ethanol. To the precursor solution can be added a solution of the same or different precursor solution followed by a catalyst, e.g., propylene oxide, and a gel is formed. If it is desired to dope the neutron absorbing material then a solution of the scintillating material such as a salt of the scintillating material can be added to the precursor solution during the step of forming the wet gel.

Once the wet gel has been formed, the wet gel is then dried to convert it into a low density solid porous matrix. Drying can be carried out by any technique known in the art for forming an aerogel. For example, drying can be carried out by supercritical drying, freeze-drying, ambient pressure drying, and the like. In one embodiment, the final drying process in making the aerogels is supercritical drying. This is where the liquid within the gel like material is removed, leaving only the matrix of the neutron absorbing material optionally doped with a scintillating material. In one embodiment, the process can be performed by, for example, prior solvent exchange with CO₂ followed by supercritical drying. Since the sol-gel process is a room-temperature process, it provides a versatile, inexpensive system that is compatible with inorganic and organic dopants for processing.

Detector 10 of the present invention further includes at least one detector element 20. Detector element 20 includes, for example, a light detection assembly including one or more photodetectors. Representative examples of such detector elements include photomultiplier tubes (PMT), photodiodes, multichannel plates, CCD sensors, image intensifiers, and the like.

Detector 10 of the present invention can further include a light reflector housing 25 for at least partially reflecting the scintillation light back towards the at least one detector element and a light shield housing 30. Light reflector housing 25 can be a housing containing any reflective coating known in the art such as white Teflon tape.

Detector 10 of the present invention may further include a data analysis system or computer system for outputting, processing, and/or analyzing detected signals. For example, the PMT emits current pulses in response to the scintillation photons. The PMT pulses are amplified, digitized with an analog to digital converter (ADC), and then binned by pulse area using a multichannel analyzer (MCA). An adjustable pulse area threshold is used to reject pulses of area less than a set value, which is useful for noise reduction. The remaining pulses are counted over fixed time intervals, yielding a detection rate.

A data analysis, or computer system thereof, can include, for example, a module or system to process information from the detector, for example, a wide variety of proprietary or commercially available computers, electronics, or systems having one or more processing structures, a personal computer, mainframe, or the like, with such systems often having data processing hardware and/or software configured to implement any one (or combination) of analyzing the data from the detector. Any software will typically include machine readable code of programming instructions embodied in a tangible media such as a memory, a digital or optical recording media, optical, electrical, or wireless telemetry signal recording media, or the like, and one or more of these structures may also be used to transmit data and information between components of the system in any of a wide variety of distributed or centralized signal processing architectures.

The following examples are provided to enable one skilled in the art to practice the invention and are merely illustrative of the invention. The examples should not be read as limiting the scope of the invention as defined in the claims.

### Example

Samples of aerogel with the following compositions were prepared: pure Gd₂O₃, Gd₂O₃ doped with Eu at 1, 5, 10, and 20% (% atoms of Gd substituted), and Gd₂O₃ doped with Tb at 1, 5, 10, and 20%. The method prepared 0.2554 M solutions of the lanthanide chlorides (GdCl₃.6H₂O (99.999% purity)), EuCl₃.xH₂O (99.99% purity), and TbCl₃.6H₂O (99.999% purity)) in ethanol (200 proof). The gadolinium chloride and dopant chloride solutions were mixed in the appropriate ratio for the desired doping. For example, a 20% Tb-doped gel would be mixed 1:4 of the Tb solution to the Gd solution by volume. Next, propylene oxide was added to the mixed ethanol solutions at a ratio of 0.38:1, by volume, as a catalyst. This solution was transferred by pipette into a mold where it would take about 15 minutes to gel. The wet gel was then removed from the mold and aged in ethanol for at least 3 days, with the ethanol being changed at least once a day. After aging, the wet gel samples were dried in a critical point dryer (Tousimis Samdri-795) to form an aerogel. The finished samples were stored in a desiccator at room temperature.

UV fluorescence characterization measurements were made for several samples. Instrumentation was assembled for neutron and gamma response characterization measurements. A two-inch diameter photomultiplier tube (PMT) (Hamamatsu R550, with B14D10 socket) was mounted in an aluminum housing having a concentric bolt flange flush with the PMT window. A two-inch diameter by two inch tall aluminum enclosure with a mating flange provided a light tight sample volume. The PMT was connected to a tube-base high voltage supply (Bridgeport Instruments hvBase-P-B14D10, positive supply). The tube base interfaced to a multichannel analyzer (Bridgeport Instruments qDAQ-4), which in turn interfaced via Ethernet to a wireless router. Custom software running on a laptop controlled the data acquisition. Individual pulses were digitized and characterized using a trace acquisition mode. Pulse area spectra were acquired using a histogram acquisition mode. Typical operating parameters were +900 V bias on the PMT, a gain resistor setting of 10.1 kiloOhms kW, and a pulse integration time of 0.5 microseconds.

Neutron response measurements were performed using the described instrumentation and a basic test fixture. A neutron emitting isotope, ²⁵²Cf (250 microCuries (mCi)), was placed in a lead shield (4″ OD, 2″ ID, ×6″ high cylinder with 1″ thick floor and cap) in close proximity to the sample container. A neutron thermalizing material or moderator, such as paraffin or high density polyethylene was placed between the lead shield and the sample container. The type, thickness, and geometry of the moderator varied, however a typical configuration was three paraffin blocks, each 2″×4″×8″ stacked to form 2″ thick by 8″ wide wall in contact with the edge of the sample cell. The lead shield attenuated the fission-gamma signature from the neutron source, while only weakly reducing the neutron flux. The moderator reduced the energy of the emitted neutrons down to the thermal range where the Gd-capture cross section is large. The detection rates were measured as a function of pulse area.

Gamma response measurements—A gamma emitting isotope, ⁶⁰Co (approx 1 millieCurie), was placed in the same fixture used for the neutron measurement. Pairs of neutron and gamma measurements were made for each sample to study the relative sensitivity. Laboratory background measurements were made for each test configuration.

Measurements on 1% and 10%-Tb doped Gd₂O₃ aerogel (nominal sample volumes of 2 cc) yielded a neutron (252Cf, 250 micro-Curie, 2″ HDPE moderator, no lead shielding) response of 850+/−150 counts per second at 10 cm range. The response to a pure gamma source at the same range (60Co, 1 milli-Curie, unshielded) was indistinguisable from the background rate, less than approximately 20 counts per seconds.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A neutron detector comprising an optically transparent, low density solid porous matrix comprising nanoparticles of a neutron absorbing material having a neutron absorption capture cross-section of at least about 70 barns for absorbing neutrons and emitting scintillation photons; and at least one detector element connected to the optically transparent neutron detector to detect fluorescence.

2. The neutron detector of claim 1, wherein the low density solid porous matrix has a density of from about of about 0.002 to about 0.2 g/cm³.

3. The neutron detector of claim 1, wherein the solid porous matrix is an aerogel.

4. The neutron detector of claim 1, wherein the nanoparticles of the neutron absorbing material have a neutron absorption capture cross-section of from about 70 barns to about 100,000 barns.

5. The neutron detector of claim 1, wherein the neutron absorbing material is substantially transparent to incoming gamma radiation.

6. The neutron detector of claim 1, wherein the neutron absorbing material comprises a compound of at least one element selected from the group consisting of Li, B, Gd, Dy and Eu.

7. The neutron detector of claim 1, wherein the neutron absorbing material comprises an oxide of Gd.

8. The neutron detector of claim 1, wherein the neutron absorbing material comprises gandolinium sesquioxide.

9. The neutron detector of claim 1, wherein the neutron absorbing material is doped with a scintillating material.

10. The neutron detector of claim 9, wherein the scintillating material comprises a rare earth element.

11. The neutron detector of claim 10, wherein the rare earth element is selected from the group consisting of Tb, Dy, Ho, Eu, Tm, Yb, Lu and mixtures thereof.

12. The neutron detector of claim 1, wherein the neutron absorbing material comprises an oxide of Gd doped with a rare earth element.

13. The neutron detector of claim 1, wherein the at least one detector element comprises a photomultiplier tube, photodiode or multichannel plate.

14. The neutron detector of claim 1, wherein the neutron detector is a hand-held or portable detector.

15. The neutron detector of claim 1, wherein the neutron detector further comprises a light reflector housing connected to the solid porous matrix.

16. The neutron detector of claim 1, wherein the neutron detector further comprises a light shield housing connected to the light reflector housing.

17. The neutron detector of claim 1, wherein the optically transparent, low density solid porous matrix substantially does not fluoresce under irradiation by gamma rays.

18. The neutron detector of claim 1, further comprising a data analysis system coupled to the at least one detector element.

19. The neutron detector of claim 1, wherein the low density solid porous matrix is an aerogel comprising nanoparticles of an element comprising Gd.

20. The neutron detector of claim 1, wherein the low density solid porous matrix is an aerogel comprising nanoparticles of an element comprising Gd doped with a rare earth element.
